(19) United States
(12) Patent Application Publication
(10) Pub. No.: US 2003/0230624 A1
(43) Pub. Date: Dec. 18, 2003

(54) Hand splatter guard

(76) Inventor: William K. Soggs, Vineland, NJ (US)

Correspondence Address: WILLIAM K. SOGGS, 838 E. ELMER ST., VINELAND, NJ, 08360, US

(21) Appl. No.: 10/125,123

(22) Filed: Jun. 12, 2002

(51) Int. Cl. B23K 5/22; B23K 37/00

(52) U.S. Cl. 228/59

(57) ABSTRACT

The Hand Splatter Guard is a new innovative way to allow a welder to no longer have to struggle with the larger, uncomfortable welding glove. By using a smaller glove, the welder now will have the capability of being more productive. The Hand Splatter Guard will eliminate injuries to the welder's hand and so down wear and tear to the glove. As the two plastic plates which will have the middle regions skillfully removed creating a radius of the contour which will allow them to go over and under the instrument fully protecting the fingers and the top of the hand where the tender muscle tissues are located. By the designed angle that the guard will be mounted on the instrument eliminating having to use a clamp.

### TECHNICAL FIELD

The present invention relates to protecting the tender muscle tissue on top of the welder's hand by eliminating splatter from ever touching the glove, which will protect the fingers too.

### BACKGROUND OF THE INVENTION

A welder uses different types of gloves for protection while performing his assignment. The gloves he chooses is the one that gives him the best comfort and confidence which is needed to bring forth the best in regards to production. The glove's cost and what makes one have to buy them more frequently is the wear and tear of the glove. Also, the size of the old welding gloves are larger and can make handling an instrument difficult sometimes. When a welder's glove becomes less like a glove and more like a hand, the control of the instrument will increase and the quality of his performance will increase by far because comfort and confidence is what is needed to succeed in anything you do. Also injuries will decrease because the Hand Splatter Guard is created to protect the part of the body that is most important when performing a welding assignment, which is the hand.

### SUMMARY

An object of the invention is to protect the welder's hands and gloves from being damaged during welding operations. An object of the invention to reduce welding expenses by protecting the welder's hand and preventing him from taking time off of work due to injuries that will make workman's compensation insurance stay at a low rate for an employer.

An object of the invention is to be able to use a smaller welding glove that will enable a welder to be more productive, put out more production, which will bring greater profits to the company. The Hand Splatter Guard will catch or block any splatter or sparks from burning the tender muscle tissue of the hand just by resting slightly on an angle totally covering the hand and the fingers.

An object of the invention is to guarantee a welder a hundred percent comfort and confidence by eliminating the clamp and will allow the device to do all the work by mounting to the instrument and creating comfort and confidence at a new level.

### BRIEF DISCRIPTION OF SEVERAL VIEWS OF THE DRAWING

FIG. 1 is the front view of the top plate with the studs.

FIG. 2 is the side view of the top plate with the studs.

FIG. 3 is the front view of the bottom plate with the holes and the lip.

FIG. 4 is the side view of the bottom plate with the holes and the lip.

FIG. 5 is the instrument with the Hand Splatter Guard mounted.

FIG. 6 is the instrument without the Hand Splatter Guard mounted.

### DETAILED DESCRIPTION OF PERFERRED EMBODIMENT

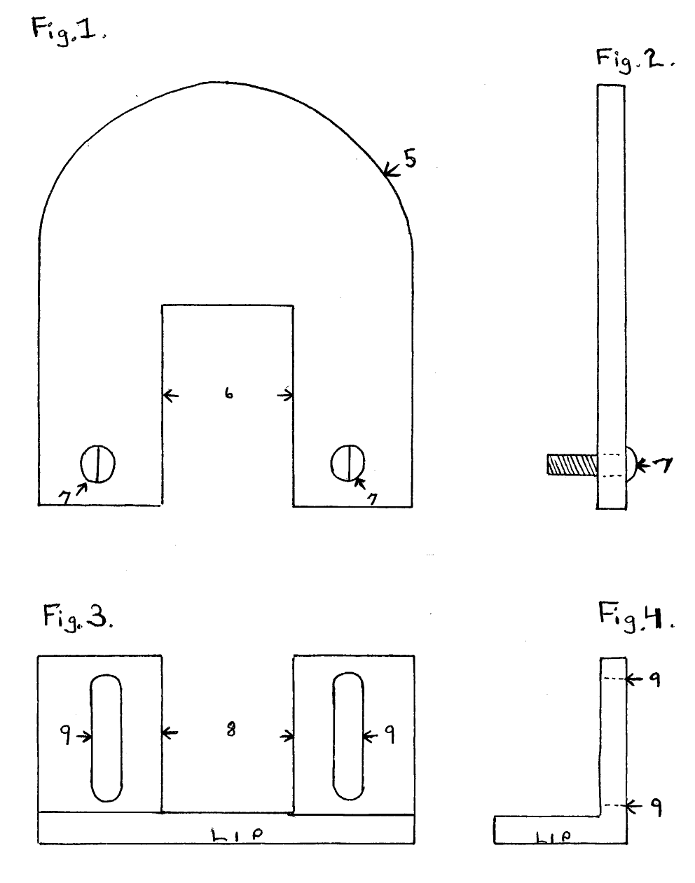

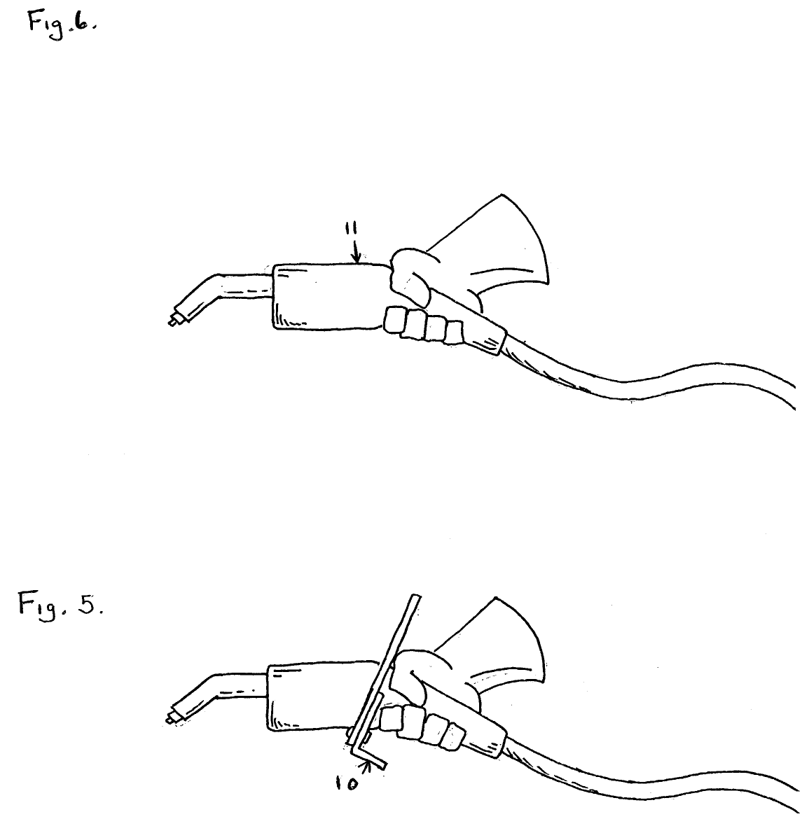

Referring to FIGS. 1-6, the Hand Splatter Guard 5 is shown includes the top plate. 6 has the inner opening in the middle region which is defined by the design of the instrument which determines the size of the contour of the opening which covers the instrument like never before. 7 the studs will be used as screws that will add to a new way of self-mounting The Hand Splatter Guard by way of detailed instructions through the development of the device. 8 now the middle of the bottom plates has an inner opening region from both sides 9 shows the two holes on each side that creates an opening for the holes to be able to join together as one when the two studs are tightened by two plastic nuts. 10 shows the instrument fully mounted with the Hand Splatter Guard 11 shows the instrument without the Hand Splatter Guard

What I claim as my invention is the hand splatter guard:

1. A Guard that protects a welders fingers and the tender muscle tissues on the top of the hand from being burnt by hot splatter that comes off the work piece while performing ones duty.
A top plate having the middle region skillfully removed which would be two inches from both sides creating a radius that would allow the top plate to rest on top of the instrument creating a protective device that sits on an angle by design to cover the area of the hand that the device is created to protect. Also, the top plate would have two studs on each side that is used for screws.
A bottom plate having the middle region skillfully removed which would be two inches from both sides and having the two holes which would be used to accommodate the two studs of the top plates as they are joined together locks both plates together creating a hedge of protection for the top of the hand and the fingers also the bottom would have a lip that would stop the splatter from burning the welder's fingers.

2. The Hand Splatter Guard of claim 1 further comprising the two studs are designed to be used as screws by not having a clamp will stop all splatter from causing discomfort and unproductively because the top and bottom plates which covers the whole instrument as well as the hand and fingers of the welder eliminating weat and tear of the welding glove.

3. The Hand Splatter Guard of claim 1 further comprising the two holes of the bottom plate which will be used to join both plates together permitting the instrument to fit like a glove and cover the hand and fingers as designed when the two plastic bolts are instituted onto the studs and are tightened.
